(19) United States
(12) Patent Application Publication
(10) Pub. No.: US 2001/0034653 A1
(43) Pub. Date: Oct. 25, 2001

(54) Point service system on the network

(76) Inventor: Yoshimasa Yamamoto, Hadano (JP)

Correspondence Address: Mattingly, Stanger & Malur, P.C, 104 East Hume Avenue, Alexandria, VA, 22301, US

(21) Appl. No.: 09/837,431

(22) Filed: Apr. 19, 2001

(30) Foreign Application Priority Data
Apr. 21, 2000 (JP) 2000-126287

(51) Int. Cl. G06F 17/60

(52) U.S. Cl. 705/14

(57) ABSTRACT

A role of a virtual shop is divided into a shop for providing a service and a vendor for providing a premium. The virtual shop is served to notice the number of provided points or the number of consumed points of a member that are given in association with a service or premium transaction. Further, a point using rule, for the case the service or premium transaction is performed, is set at the system host side, in which rule the virtual shop may change the number of points.

### BACKGROUND OF THE INVENTION

The present invention relates to a point service system which provides the points corresponding to a commodity including a service when it is purchased, and more particularly to the point service system which is intended for transactions on a network.

As prior arts on a point service system that is intended for transactions on a network, there has been proposed “Method for issuing service ticket in article transaction using communication line” as disclosed in JP-A-9-245256 and “Point service system for virtual shopping center” disclosed in JP-A-10-78989. The prior art of JP-A-9-245256 is arranged so that the service tickets to be issued by a shop in transactions with a customer through a communication line are managed on each customer's unit and the service tickets of each customer are given back at the next intended transaction in the form of a price cut or a premium. The prior art of JP-A-10-78989 is arranged so that the common points to be issued at a point-issuing rate set for each shop when a virtual shop transacts with a customer are managed on each customer's unit and the payment is cut at the point-giving-back rate set for each shop in the next intended transaction by the customer with the shop.

The prior art disclosed in JP-A-9-245256 has a capability of merely providing a fixed and uniform service. This prior art thus has difficulty in applying itself to a variety of shops run by their respective managers. The prior art disclosed in JP-A-10-78989 is arranged to perform giving-back of the points through the payment cut. This prior art thus has difficulty in coping with an illegal deed or bankruptcy of a specific shop (adjustment).

### SUMMARY OF THE INVENTION

It is an object of the present invention to provide a point service system which is arranged to overcome the foregoing difficulties, allow any virtual shop and customer to safely join the system itself and any virtual shop to flexibly and rapidly change a ratio of a service to the corresponding points for prompting sales on the shop's own decision so that the system may cover a variety of shops run by their own managers as its joining member.

In order to meet the condition that the virtual shop and a customer can join the system safe and sound, the present invention prepares three means. As a method of giving back the points to a customer, a method of giving back the premium corresponding to the number of points obtained by the customer is adopted in place of the method of cutting the payment in a new transaction. In order to realize this method, the point service system is provided with a function of supporting a shop for providing a service (including a commodity, which holds true to the following term “service”) and the other function of supporting a vendor for providing a premium. Then, the procedure of giving a qualification to a virtual shop that intends to join the system on the proper examination and then distributing a key to the qualified virtual shop is adopted for the purpose of suppressing the adverse influence taking place in an illegal deed or bankruptcy of a specific shop. Further, by considering a time passage, the present point service system provides a capability of making a term-determined contract with a virtual shop, storing the transactions data in an inside database as trace information, and determining the validity of the continuation of the contract on the stored data.

The point service system according to the invention has a rule of defining an upper limit and a lower limit of a ratio of a service to the corresponding points inside the system itself. According to this rule, the virtual shop enables to define the number of points at each transaction of a service or a premium and communicates it to the host computer having the point service system itself. The point service system hence enables to flexibly and rapidly change the ratio of a service to the corresponding points on the virtual shop's own decision.

Moreover, the point service system according to the invention has a capability of storing family information in which a group of customers are treated as a family unit. This capability makes it possible to realize a more convenient point service system. Moreover, the point service system includes a function corresponding to the virtual shop itself so that a firm having no virtual shop as a business base can join the system.

### BRIEF DESCRIPTION OF THE DRAWINGS

FIG. 1 is a block diagram showing an overall arrangement of a point service system according to the present invention;

FIG. 2 is a view showing essential information managed in a database provided in the point service system of the present invention;

FIG. 3 is a view showing essential information stored in the database for operating the point service system according to the present invention;

FIG. 4 is a flowchart showing a procedure of registering a shop as one form of a virtual shop in the point service system according to the present invention;

FIG. 5 is a flowchart showing a procedure of registering a customer member in the point service system according to the present invention;

FIG. 6 is a flowchart showing a procedure of registering a vendor as one form of a virtual shop in the point service system according to the present invention;

FIG. 7 is a view showing a procedure of processing points in a transaction of a service in the point service system according to the present invention;

FIG. 8 is a view showing a procedure of processing points in a transaction of a premium in the point service system according to the present invention;

FIG. 9 is a view showing a main content of a message to be treated by a host of the point service system according to the present invention;

FIG. 10 is a flowchart showing a procedure of managing a contract term of the point service system according to the present invention with the shop as an example;

FIG. 11 is a flowchart showing a procedure of creating statistical information in the point service system according to the present invention;

FIG. 12 is a block diagram showing a computer of the host of the point service system according to the present invention;

FIG. 13 is a block diagram showing a computer of the shop of the point service system according to the present invention;

FIG. 14 is a block diagram showing a computer of the member of the point service system according to the present invention;

FIG. 15 is a block diagram showing a computer of the vendor of the point service system according to the present invention;

FIG. 16 is a block diagram showing an overall arrangement of a point service system according to another embodiment of the present invention;

FIG. 17 is a view showing an example of a Web screen provided by the point service system according to the present invention;

FIG. 18 is a view showing one example of a business flow at a preliminary stage of the point service system according to the present invention; and

FIG. 19 is a view showing one example of a business flow at a promoting stage of the point service system according to the present invention.

### DESCRIPTION OF THE EMBODIMENTS

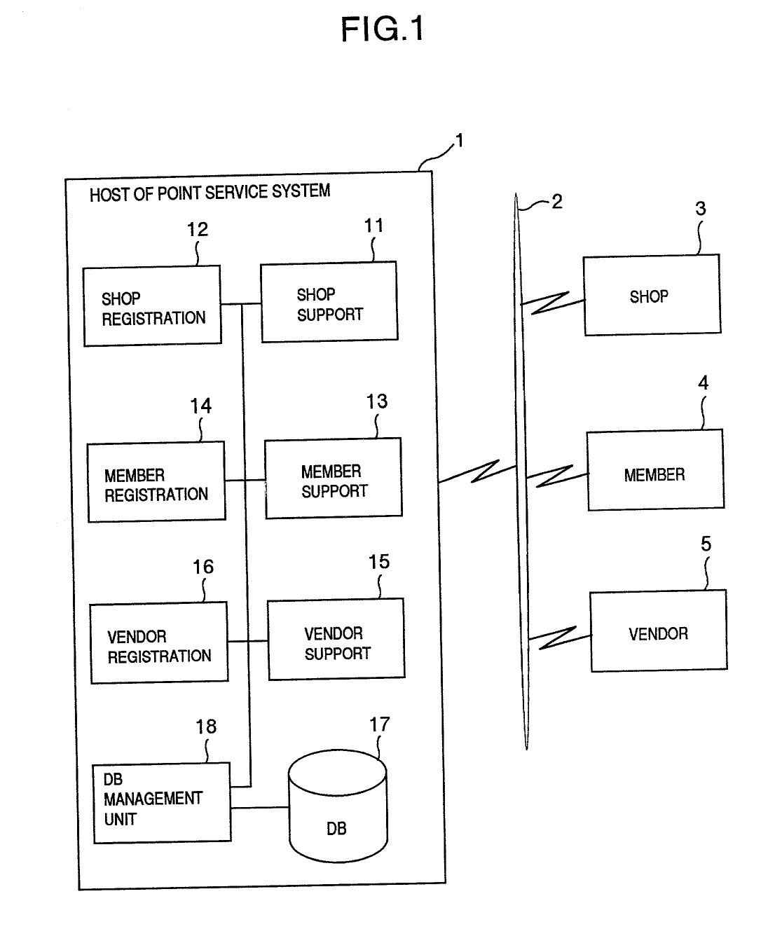

FIG. 1 shows an overall arrangement of a point service system according to an embodiment of the present invention.

The point service system is arranged to have a computer 3 (referred to as a shop) in which provided is a virtual shop for providing a service and the corresponding points thereto to a customer, a computer (referred to as a vendor) in which provided is a virtual shop where a customer can purchase a premium using his or her points, a computer 4 to be used by a customer (also referred to as a member) who purchases a premium in the vendor by consuming the points, a host computer 1 that has the point service system itself for providing point services, and a network 2 to be connected if necessary, such as the internet.

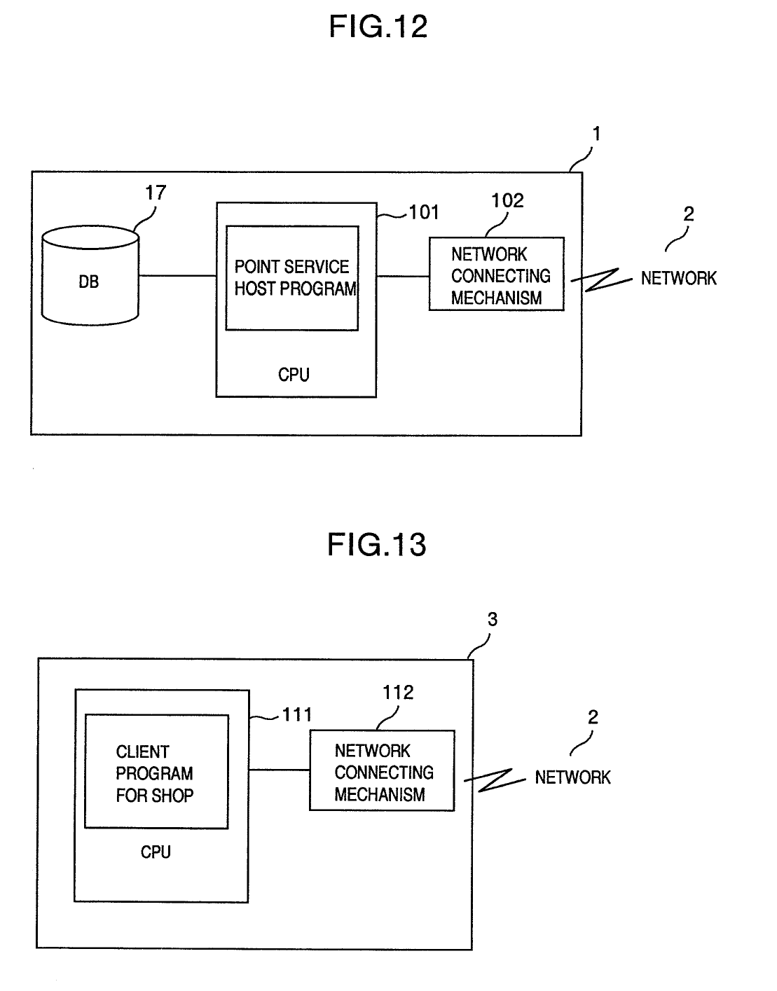

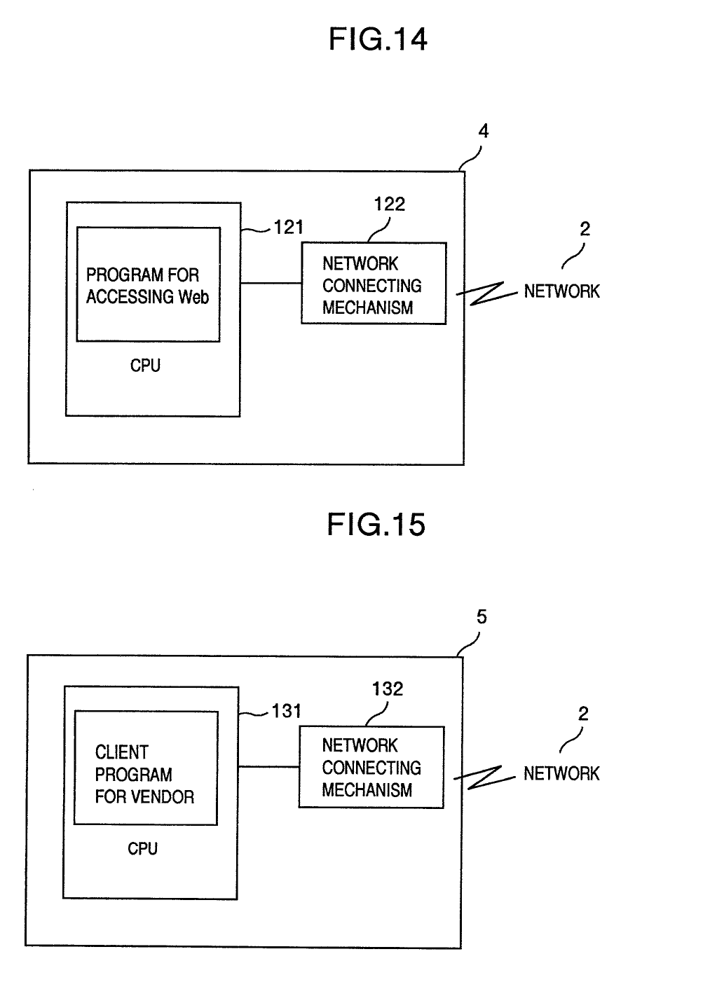

Then, the description will be oriented to the arrangement of a computer in which the point service system is operated. As shown in FIG. 12, the computer of the host 1 is arranged to have a database 17 (referred to as a DB) for storing information necessary to the point service, a CPU 101 that enables the point service host program for performing the point service to be operated through the use of the DB 17, and a network connecting mechanism 102 for connecting to another computer through the network. The shop computer 3 is, as shown in FIG. 13, arranged to have a CPU 111 that enables the client program for a shop to be operated and a network connecting mechanism 112 to be connected with another computer through a network, the client program for a shop serving to communicate information on a service transaction to the host 1 of the point service point system when a service transaction with the customer takes place. Likewise, the vendor computer 5 is, as shown in FIG. 15, arranged to have a CPU 131 for enabling a client program for a vendor to be operated and a network connecting mechanism 132 to be connected with another computer through a network, the client program for a vendor serving to communicate information on a premium transaction to the host 1 of the point service system when a premium transaction with the customer takes place. Further, the member computer 4 is, as shown in FIG. 14, arranged to have a CPU 121 for enabling a program for accessing a WEB to be operated and a network connecting mechanism 122 to be connected with another computer through a network, the program for accessing a WEB serving to access the host 1 of the point service system. The network connecting mechanisms 102, 112, 122 and 133 that are all components of the point service system provide means for encrypting communication information for protecting that from malignant intruders.

In turn, the description will be oriented to the function of the point service host program that is operated on the host 1 of the point service system with reference to FIG. 1.

The host 1 includes a shop support unit 11 for making the information to be stored in the host open to the shop 3, a shop registration unit 12 for examining and registering a shop and a service to be treated by the shop, a member support unit 13 for making the information to be stored in the host open to the member 4, a member registration unit 14 for examining and registering a member, a vendor support unit 15 for making the information to be stored in the host open to the vendor 5, a vendor registration unit 16 for examining and registering a vendor and a premium to be treated by the vendor, a database unit 17 for storing information required for the point service, and a DB managing unit 18 for referring to and updating the DB.

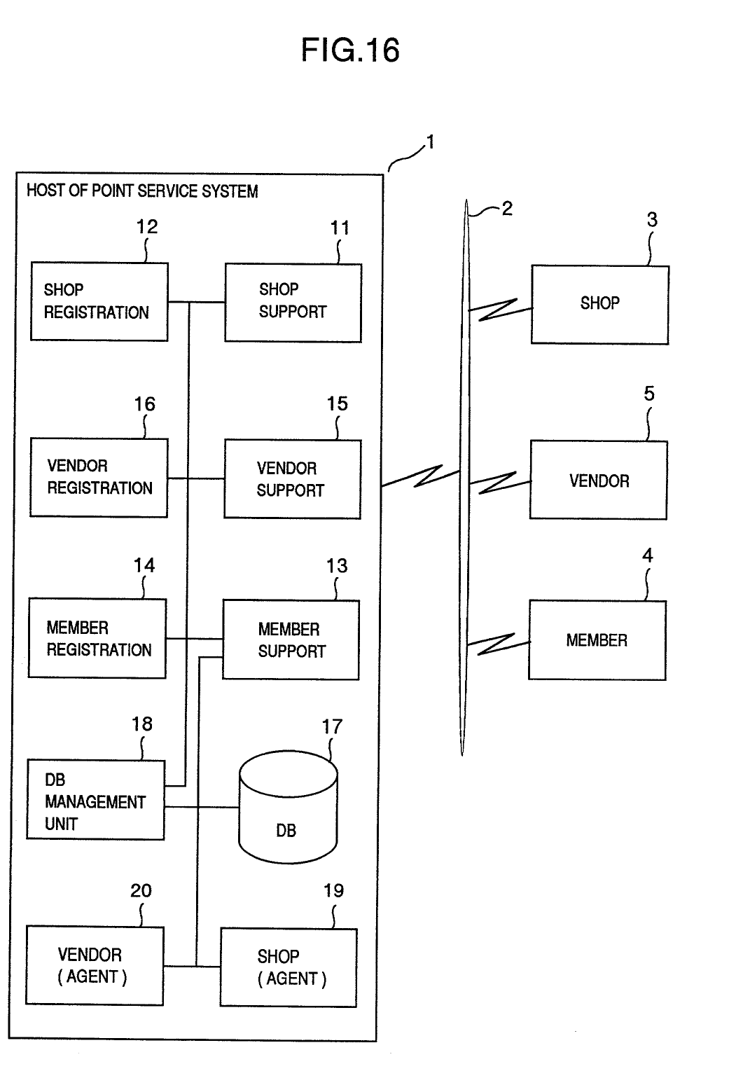

FIG. 16 shows an overall arrangement of another embodiment of the point service system that includes in the point service system a shop (agency) 19 corresponding to a shop 3 and a vendor (agency) 20 corresponding to the vendor 5 and serves to exchange information on a service transaction and information on a premium transaction through inter-program communicating means inside the host 1 without through the network 2.

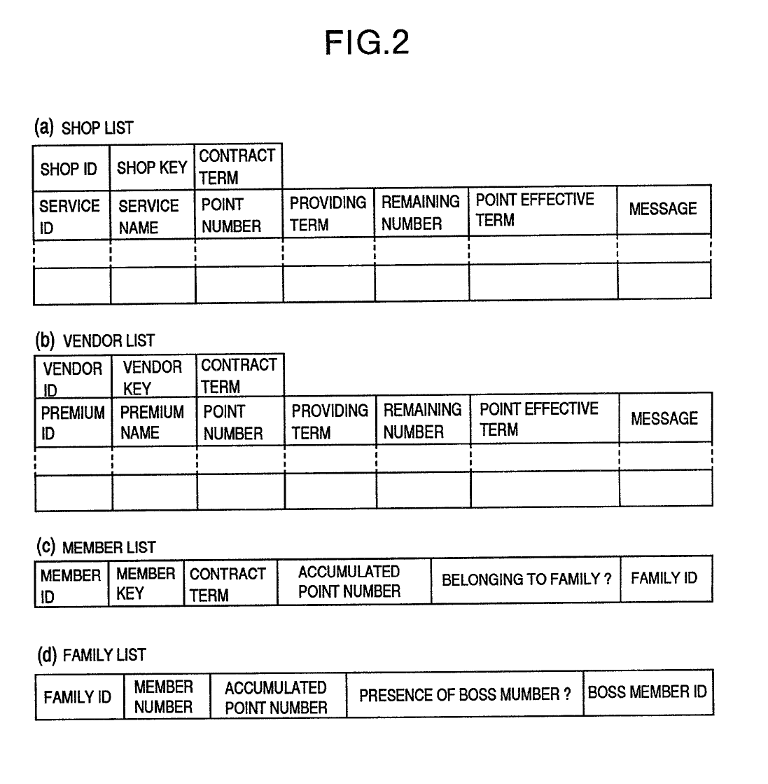

Next, the essential information to be managed by the DB for the point service is shown in FIG. 2.

The list of the shops shown in (a) of FIG. 2 includes an ID by which the host identifies each shop, a key given by the host to each shop, a contract term between the host and each shop, an ID of each service given by the shop, a name of the service, the number of points provided to the customer when the service is purchased, a service-providing term and the remaining number of the service, a point effective term when provision of the points to the service is guaranteed, and a message by which the shop appeals to the member. The list of the vendor shown in (b) of FIG. 2 includes an ID by which the host identifies the vendor, a key given by the host to the vendor, a term of contract with the vendor, an ID of each premium provided by the vendor, a name of the premium, the number of points consumed by the customer for the premium by the customer, a premium-providing term and the remaining number of the premium, a point effective term when provision of the number of points required for the premium is guaranteed, and a message by which the vendor appeals to the member. The list of the member shown in (c) of FIG. 2 includes an ID by which the host identifies each member, a key given by the host to the member, a term of contract with each member, the number of accumulated points of each member, information for discriminating whether or not the member belongs to a specific family, and information for identifying the family. The list of the family shown in (d) of FIG. 2 includes an ID by which the host identifies the family, the number of the members composing each family, the number of accumulated points which is the sum of the points of all members of the family, information for determining in the family a boss member who occupies a right of exchanging a premium with the points obtained by the family, and an ID of the boss member.

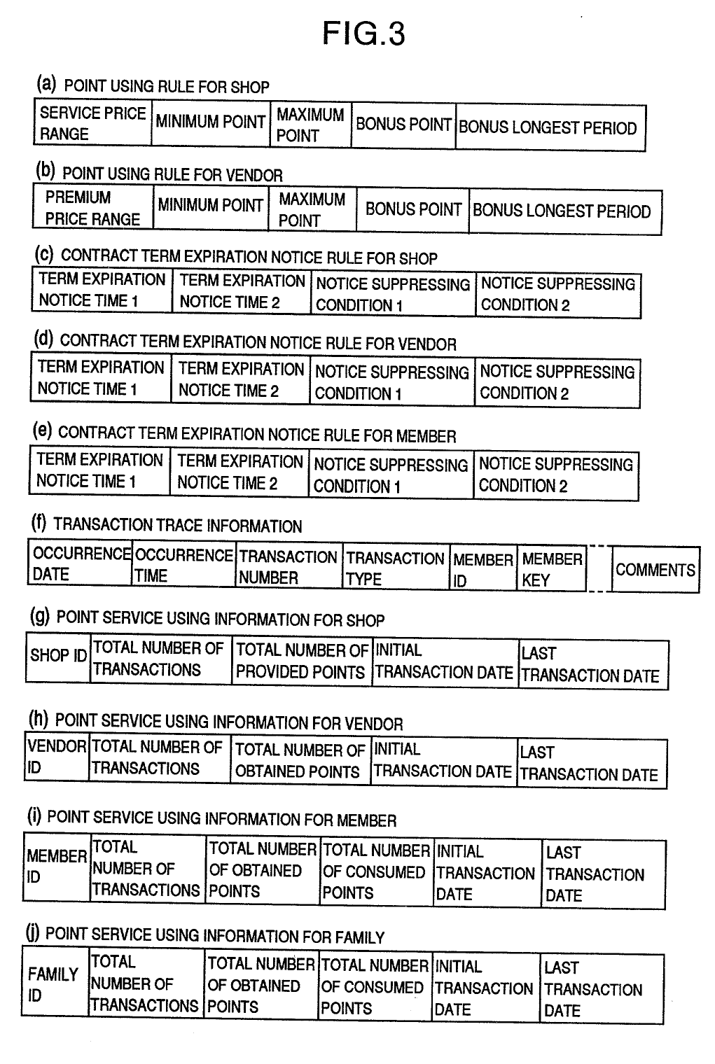

Then, the essential information to operating the system, stored on the DB, is shown in FIG. 3.

The point using rule for a shop shown in (a) of FIG. 3 includes a service price range, a lower limit value and an upper limit value of the point number corresponding to the service price range, an upper limit value of the bonus point in which the service can be provided with points more than the upper limit value within a certain term for sales, and a term when the bonus points are effective. The point using rule for a vendor shown in (b) of FIG. 3 includes a price range of a premium, a premium price range, a lower limit value and an upper limit value of the point number corresponding to the price range, a lower limit value of the bonus points in which each premium can be provided with points less than the lower limit value within a certain term for sales, and a term when the bonus points are effective. The expiration noticing rules for a shop/vendor/member shown in (c) to (e) of FIG. 3 each include one or more expiration noticing times for specifying a time when the contract update time is coming close and one or more notice suppressing conditions for suppressing the expiration notice. The trace information for transactions shown in (f) of FIG. 3 includes a date and time of each transaction taking place between the system and a shop/vendor/member, an unique transaction number specified for each transaction, a type of transaction, an ID of a member who performs a transaction, and a key thereof. The point service using information of a shop/vendor/member/family shown in (g) to (j) of FIG. 3 includes an information for identifying a shop/vendor/member/family, a total number of transactions, a total number of treating the points, and a first and a last transaction dates.

In succession, the description will be oriented to the procedure of registering a shop, a member and a vendor.

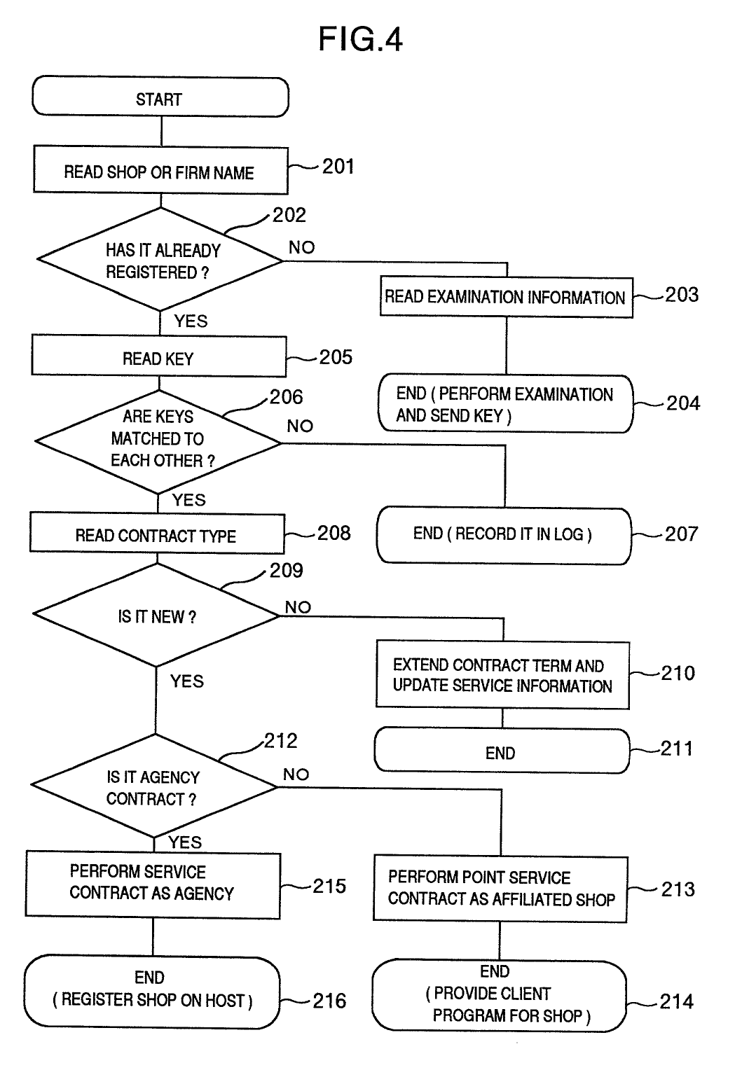

At first, the summary of the procedure of registering a shop, which is performed in the shop registering unit 12, will be described with reference to the flowchart shown in FIG. 4.

When the shop 3 makes access to the shop registering unit 12, the unit requests the name of a shop or a firm of the shop 3 (201). Then, the operation is executed to compare the inputted name of the shop or firm with the ID of the shop listed in the DB 17 and determine if it has been already registered on the compared result (202). If it is not registered in the shop list, the request for the necessary examination information to registration is given to the shop 3 (203). Then, the examination information is read and the operation is temporarily finished (204). If no problem takes place as a result of performing a manual examination, a key is sent. If it is registered in the shop list, an operation is executed to request the shop 3 to input the key (205). Then, the inputted key is collated to the registered key in the shop list (206). If the keys are not matched, the operation is finished (207) and then the fact is recorded in a log. The collation of the keys may be retried several times. If the keys are matched to each other, the operation is executed to request the shop 3 to input a contract type (208). It is determined if the contract is new (209). If it is not new, the operation is executed to extend the contract and update the service information provided by the shop 3 for updating the content of the shop list stored in the DB 17 (210), and then the operation is finished (211). If it is new, the operation is executed to determine if it is an agency contract that entrusts the sales to the host 1 (212). If it is not the agency contract, the operation is executed to make a contract of joining a member of the point service, receive the necessary information to the shop list stored in the DB 17, and add it to the shop list (213) so that the client program for a shop can be downloaded, and then the operation is finished (214). The client program for a shop may be provided through a recording medium such as a floppy disk or a CD-ROM. If it is the agency contract, the operation is executed to make an agency contract of a service, receive the necessary information to the shop list in the DB 17, and add it to the shop list (215), and then the operation is finished. Next, the shop (agency) is manually registered in the host 1 (216). The shop support unit 11 provides an interface by which the shop 3 have a conversation with the shop registering unit 12 and another interface by which part of the information stored in the DB 17 is referred by the shop 3.

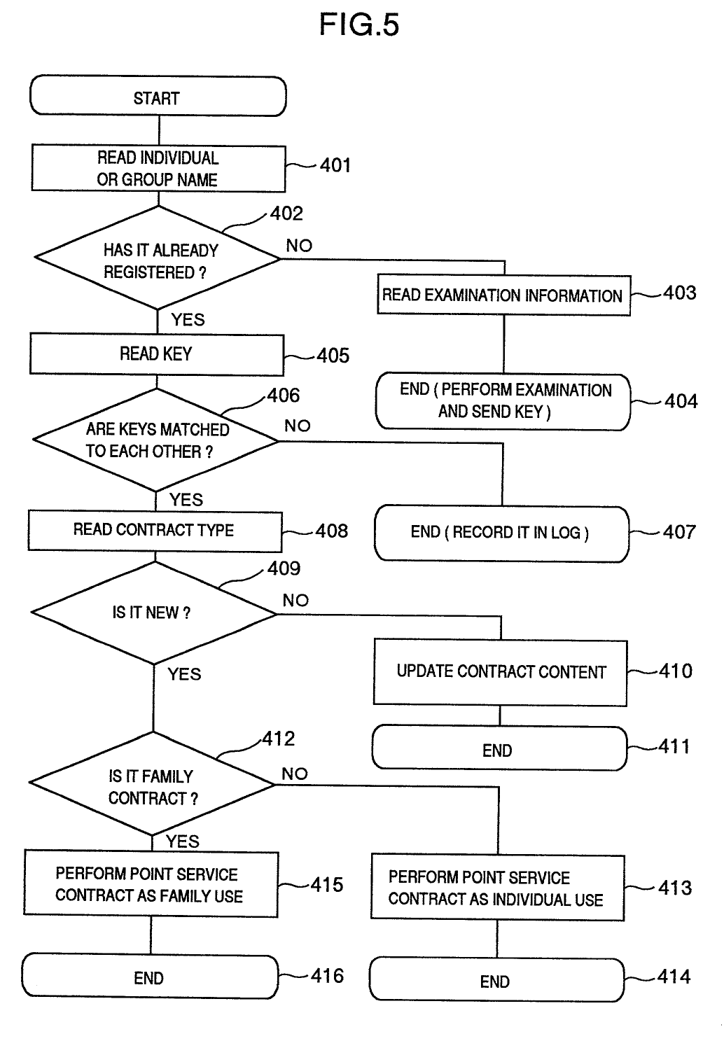

Turning to the flowchart of FIG. 5, the summary of the procedure of registering a member, performed by the member registering unit 14, will be described.

When a member 4 makes access to the member registering unit 14, the member registering unit 14 requests an individual or body name of member 4 (401). The inputted individual or body name is compared with a member ID in the member list stored in the DB 17 for determining if it has been already registered (402). If it is not registered in the member list, the operation is executed to request the necessary examination information to the registration of the member 4 (403), and read the examination information, and then the operation is temporarily finished (404). If no problem takes place as a result of performing the manual examination, a key is sent to the member 4. If it has been already registered in the member list, the member 4 is requested to input the key (405). Then, the inputted key is collated to the key registered in the member list (406). If the keys are not matched, the operation is finished (407) and the fact is recorded. The collation of the keys may be retired several times. If the keys are matched, the operation is executed to request the member 4 to input a contract type (408), for determining if it is a new contract (409). If it is not new, the operation is executed to update the contract content for updating the content of the member list stored in the DB 17 (410), and then the operation is finished (411). If it is a new contract, it is determined if the contract is a family one (412). If it is not a family contract, the operation is executed to make an individual contract for the point service, receive the necessary information, and add it to the member list stored in the DB 17 (413), and then the operation is finished (414). If it is a family contract, the operation is executed to make a family contract, receive the necessary information, and add it to the member list and the family list stored in the DB 17 (415), and then the operation is finished (416). The member support unit 13 provides an interface by which the member 4 has a conversation with the member registering unit 14 and another interface by which part of the information stored in the DB 17 is referred by the member 4.

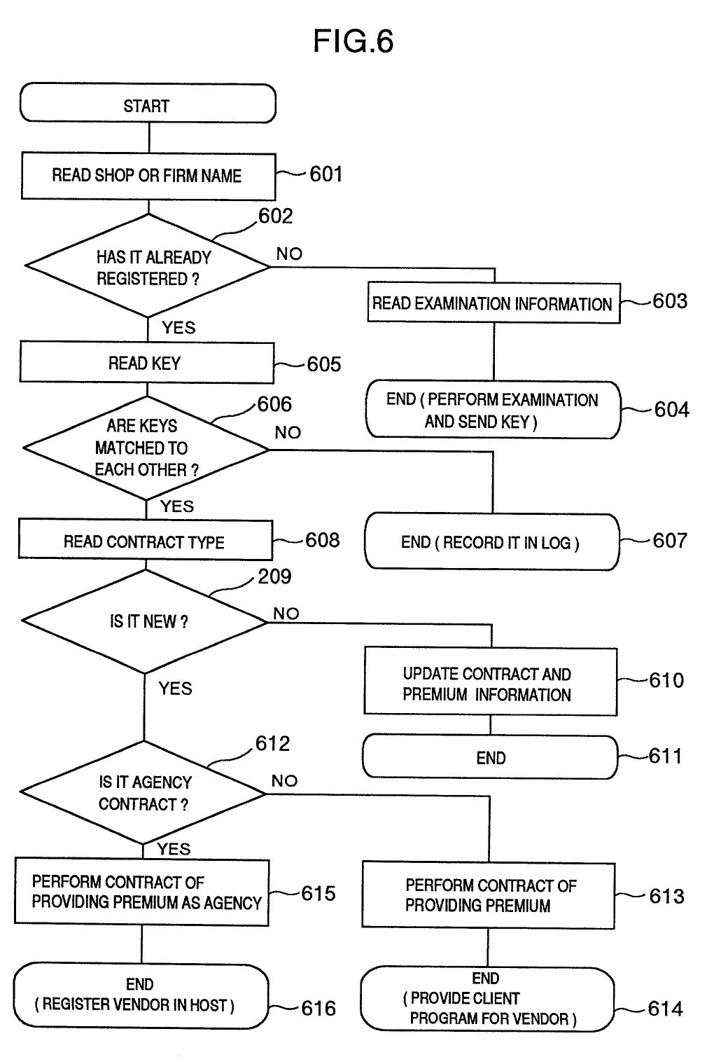

Turning to the flowchart of FIG. 6, the description will be oriented to a summary of the procedure of registering a vendor, performed by the vendor registering unit 16.

When the vendor 5 makes access to the vendor registering unit 16, the operation is executed to request the name of the shop or firm of the vendor 5 (601). The inputted name of the shop or firm is compared with each vendor ID in the vendor list stored in the DB 17 for determining if it has been already registered in the vendor list (602). If it is not registered in the vendor list, the operation is executed to request the necessary examination information to the registration from the vendor 5 (603), and read it, and then the operation is temporarily finished (604). If no problem takes place as a result of the manual examination, a key is sent to the vendor 5. If it has been already registered in the vendor list, the operation is executed to request the vendor 5 to input the key (605). The inputted key is collated to each key registered in the vendor list (606). If the keys are not matched, the operation is finished (607) and then the fact is recorded in a log. The collation of the keys may be retried several times. If the keys are matched, the operation is executed to request the vendor 5 to input a contract type (608), for determining if it is a new contract (609). If it is not new, the operation is executed to extend the contract and update the premium information provided by the vendor 5 for updating the content of the list of the vendor 5 stored in the DB 17 (610), and then the operation is finished (611). If it is new, the operation is executed to determine if it is an agency contract that entrusts a sale to the host 1 (612), if it is not an agency contract, the operation is executed to make a contract of providing a premium, receive the necessary information to the list of the vendor 5 stored in the DB 17 and add it to the list (613) so that the client program for a vendor may be downloaded. Then, the operation is finished (614). The client program for a vendor can be provided through a recording medium such as a floppy disk or a CD-ROM. If it is an agency contract, the operation is executed to make an agency contract for providing a premium, receive the necessary information to the vendor list in the DB 17, and add it to the list (615). Then, the operation is finished. Next, the vendor (agency) is manually registered on the host 1 (616). The vendor support unit 15 provides an interface by which the vendor 5 has a conversation with the vendor registering unit 16 and another interface by which part of the information stored in the DB 17 is referred by the vendor 5.

In succession, the description will be oriented to the information exchange between the registered shop/member/vendor and the host of the point service system.

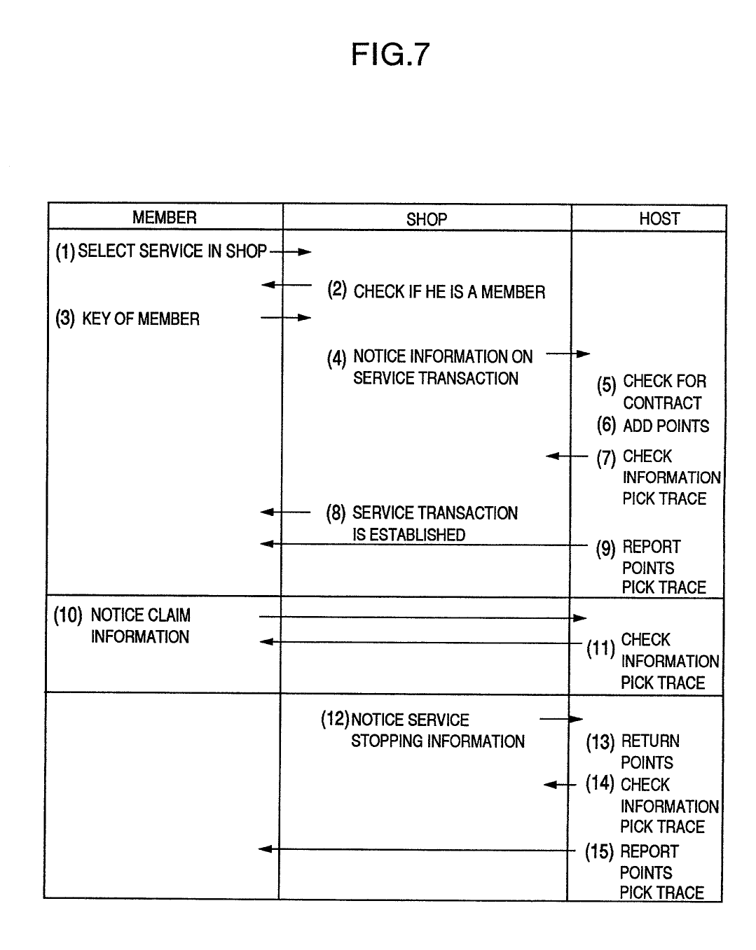

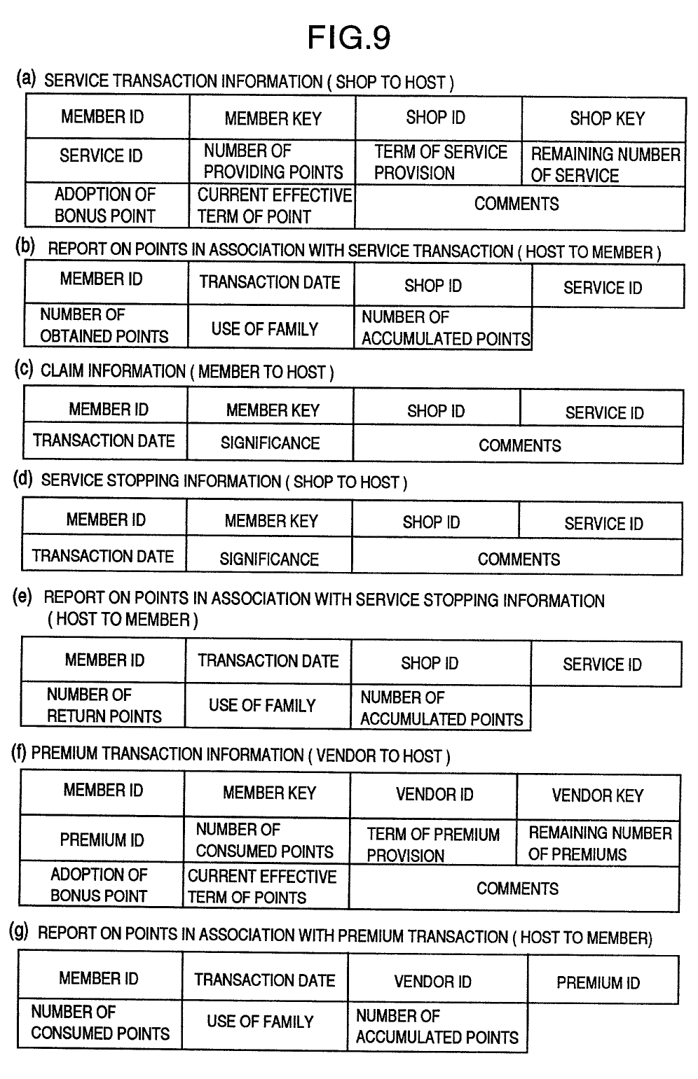

At first, the procedure of handling points in association with the service transactions will be described with reference to FIG. 7. In the following description, the host 1 is titled as ABC and the member 4 who joins the host 1 is called a ABC member. Moreover, the shown shop 3 may be a virtual shop outside the host (affiliated shop) or a virtual shop inside the host (agency). When the member 4 purchases a specific service in the shop 3 (1), if the service is registered in the ABC, the shop 3 requests a key having been given from the ABC of the member 4 (2), creates information on the service transaction including the key (3) sent from the member 4 and the number of points to be supplied according to the purchased service, and notify the host 1 of the ABC of the information (4). The essential content of the information on the service transaction is listed in (a) of FIG. 9. The shop support unit 11 of the host 1 refers to the DB 17 for checking the key collation and the contract status of the member/shop by using the member list and the shop list included in the DB 17 and the validity of the number of points by using the point using rule for the shop (5). If no problem is found, the number of points supplied for this time is added to the number of points of the member in the DB 17 for updating it (6) and then the check information is sent to the shop 3 (7). If a problem is found on the key collation of the member/shop, the contract status check or the validity of the number of points, the check information for indicating the fact is sent to the shop 3. In response to the check information for indicating no problem is found, the shop 3 notifies the member 4 of the fact that the shop 3 start dealings with the member 4 (8). At a time, the shop 3 reports the information containing the number of points to be supplied for this time to the member 4 through the member support unit 13 of the host 1 (9). The essential content of the report on the points in association with the service transaction is listed in (b) of FIG. 9.

If a problem is found on the service purchased from the shop 3 joining the ABC, the member 4 notifies the host 1 of the claim information containing the information on the member/shop/service (10). The essential content of the claim information is listed in (c) of FIG. 9. The member support unit 13 of the host serves to refer to the DB 17 for checking the information on the transaction between the member and the shop and then send the check information to the member 4 (11).

If such a problem as no payment to the service by the member 4 though the points are supplied to the member 4 joining the ABC, the shop 3 notifies the host 1 of the information on the service stop containing the information on the member/shop/service (12). The essential content of the information on the service stop is listed in (d) of FIG. 9. The shop support unit 11 of the host 1 serves to refer to the DB 17 for checking the information on the transaction between the member and the shop, perform a process of returning the points to the member listed in the DB 17 (13), and send the check information to the shop 3 (14). At a time, the shop support unit 11 reports the information containing the number of returned points of this time to the member 4 through the member support unit 13 of the host 1 (15). The essential content of the point report in association with the information on the service stop is listed in (e) of FIG. 9.

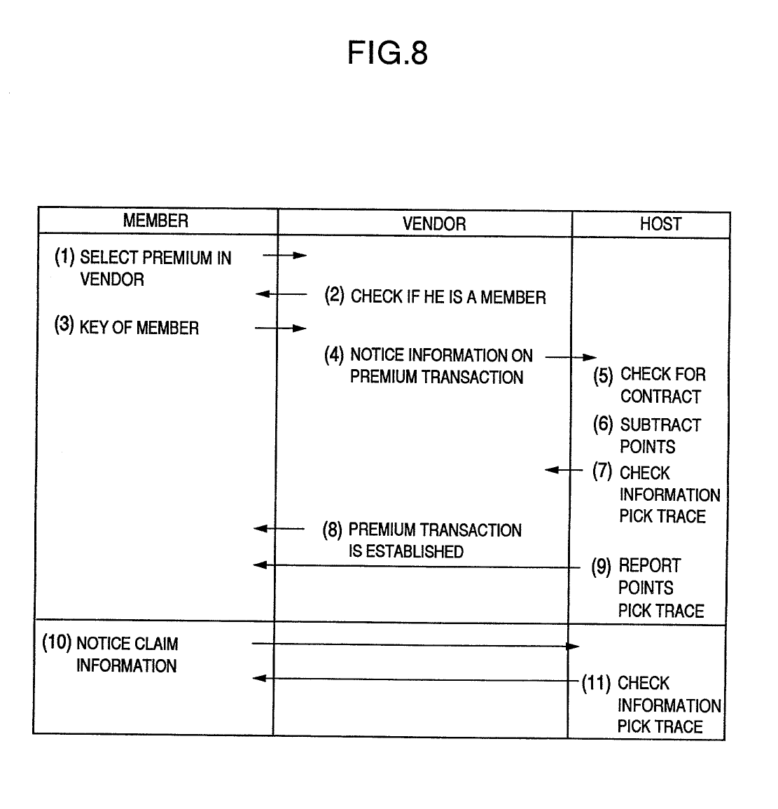

Turning to FIG. 8, the procedure of handling the points in association with the transactions of the premiums. The vendor 5 shown in FIG. 8 may be a virtual shop outside the host (affiliated shop) or a virtual shop inside the host (premium section). When the member 4 purchases a specific premium in the vendor 5 (1), if the premium is registered in the ABC, the vendor 5 requests of the member 4 a key having been given by the ABC (2), creates the information on the premium transaction containing the number of points consumed by the member 4 in purchasing the premium, and reports the information to the host 1 of the ABC (4). The essential content of the information on the premium transaction is listed in (f) of FIG. 9. The vendor support unit 15 of the host 1 serves to refer to the DB 17 for checking a key collation, a contract status, a number of points of a member/family by using the member list, the vendor list and the family list in the DB 17 as well as the validity of the number of points by using the point using rule for the vendor (5). If no problem is found, the number of consumed points of this time is subtracted from the number of points of the member in the DB 17 for updating the content in the DB 17 (6). Then, the vendor support unit 15 sends the check information to the vendor 5 (7). Herein, if a family attribute is listed in the member list 4, the total number of points of the family is to be checked. If a problem is found on the key collation of the member/vendor, the contract status check, and the validity of the number of points also in the case that the boss member is specified and another member rather than the boss member issues a request for exchanging the premium, the check information on that is sent to the vendor 5. In response to the check information for indicating no problem, the vendor 5 notifies the member 4 of the fact that the vendor 5 enters into dealings with the member 4 (8). At a time, the vendor 5 reports the information including the number of consumed points of this time to the member 4 through the member support unit 13 of the host 1 (9). The essential content of the point report in association with the transaction on the premium is listed in (g) of FIG. 9. If a problem takes place on the premium purchased from the vendor 5 joining the ABC, the member 4 notifies the host 1 of the claim information containing the information on the member/vendor/premium (10). The member support unit 13 of the host 1 serves to refer to the DB 17 for checking the information on the transaction between the member and the vendor and then send the check information to the member 4 (11).

The exchange of the information between the shop/member/vendor and the host of the point service system is accumulatively recorded as the trace information on the transactions in the DB 17 in which trace information the date and time, the serial number and the type of each transaction are added at each exchange of information by means of the shop support unit 11, the member support unit 13 and the vendor support unit 15.

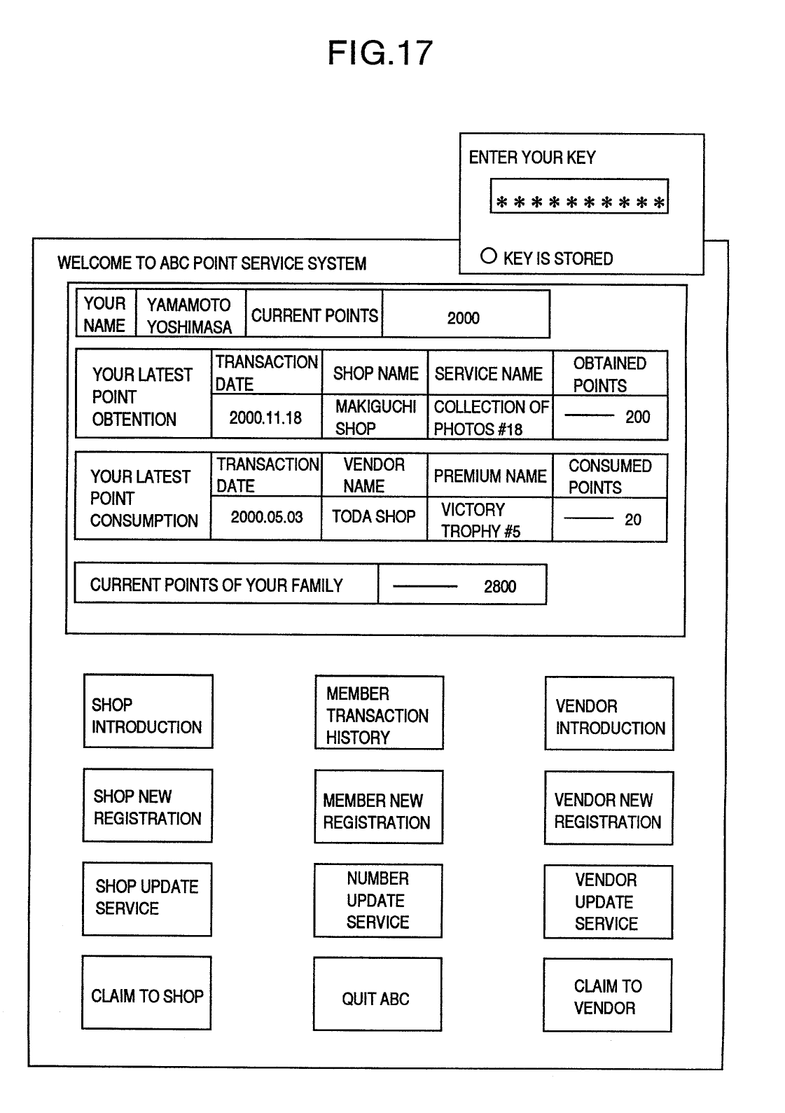

One example of the Web screen supplied to the member 4 by the host 1 of the point service system is shown in FIG. 17.

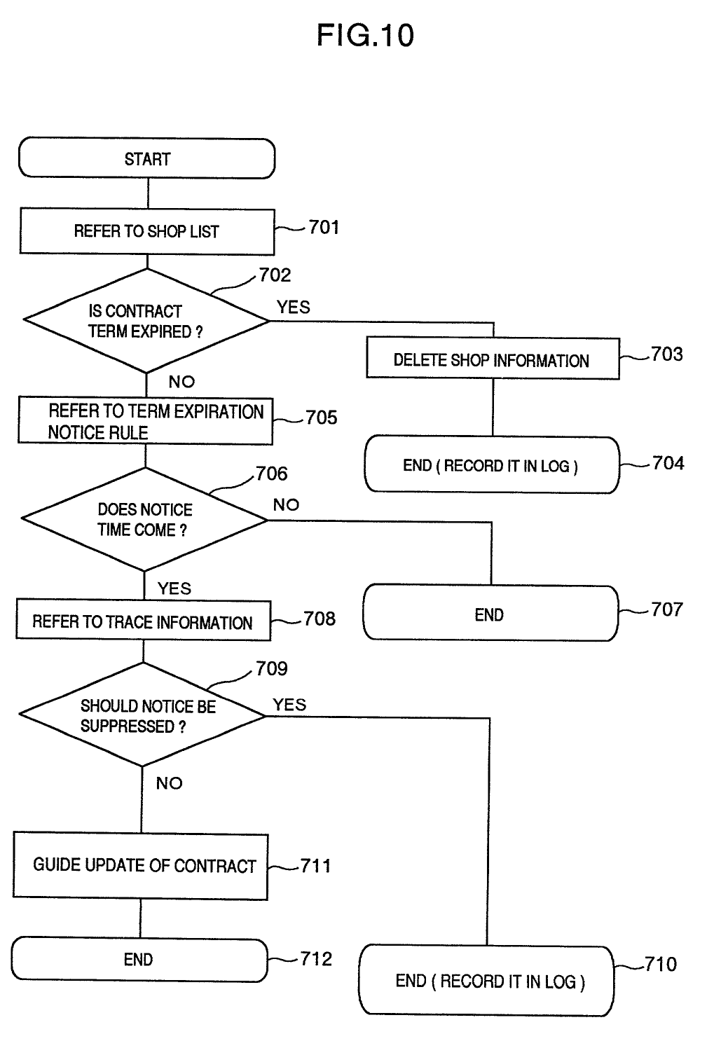

In succession, the summary of the management on the term of contract that is one of the functions of the DB managing unit 18 will be described with reference to the flowchart of FIG. 10 with the shop as an example. In the DB management unit 18, the procedure of the management on the term of contract is carried out for the shop list, the vendor list and the member list stored in the DB 17 once a day when a new day comes.

The procedure of the management on the term of contract of the shop is executed to sequentially refer to the shop list stored in the DB 17 (701), if the contract term of the shop 3 is expired on the execution day (702), delete the information of the shop 3 from the shop list, and record it in a log, and is finished and shifts to the next process for the shop (704). If the contract term of the shop 3 is not expired, the procedure is executed to refer to a contract term expiration notice rule for the shop (705), unless it conforms to one or more notice times (for example, ten days before the contract due date) (706), and is finished and shifts to the next process for the shop (707). If it conforms to one of the notice times (for example, ten days before the contract due date), the procedure is executed to refer to the trace information (708). If the current case conforms to one or more notice suppressing conditions (for example, zero transaction within the term of contract, 100 or more claims from the members within the term of contract) of the contract term expiration notice rule for the shop (709), it is recorded in a log and then the procedure is finished and then shifts to the next process for the shop (710). Unless it conforms to one of the notice suppressing conditions, the update of the contract is guided through the shop support unit 11 (711). Then, the procedure is finished and then shifts to the next process for the shop (712). At this stage, in the case that the contract term is expired in one or more members when the procedure of the management on the term of contract of all the members is finished, if the member has a family attribute and the contract terms of all the members belonging to the family are expired, the family information is deleted from the family list.

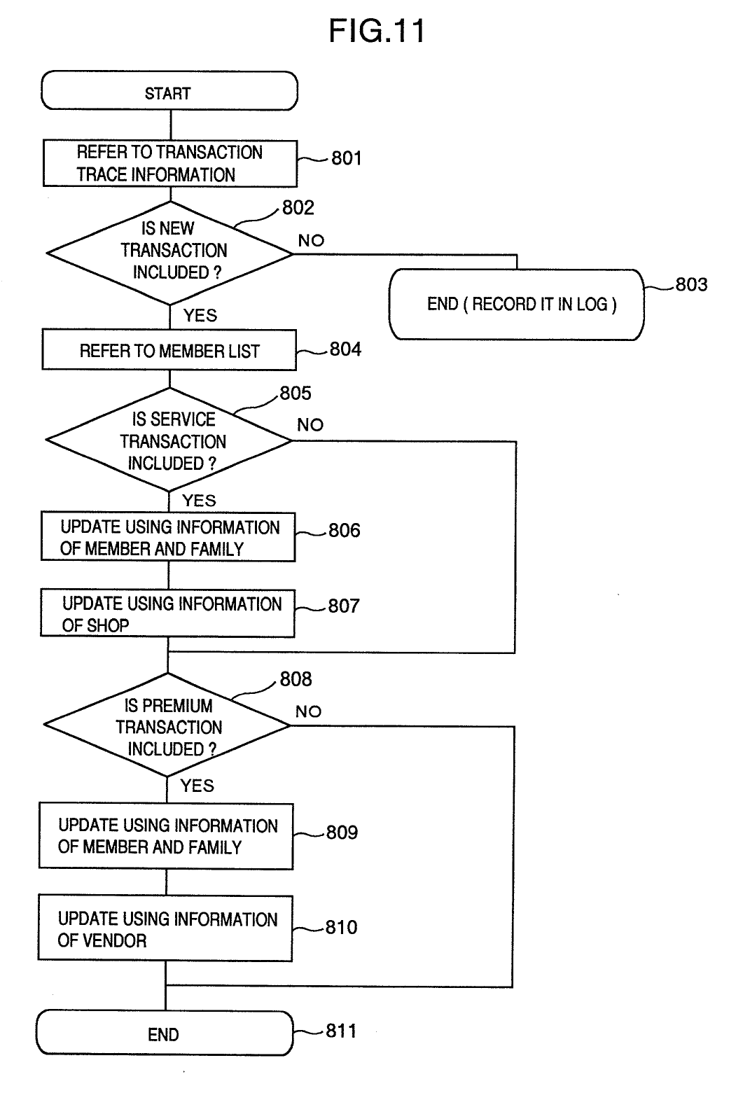

In succession, the summary of the procedure of creating the statistical information that is one of the functions of the DB managing unit 18 will be described with reference to the flowchart of FIG. 11. Herein, the description will be oriented to the procedure in which the DB managing unit 18 creates the statistical information once a month when a new month comes.

The procedure of creating the statistical information is executed to refer to the trace information on the transactions stored in the DB 17 (801) and, if there is not a new transaction after the one previous time of creating the statistical information (802), record the fact in the log and then is finished (803). If one or more transactions are found, the procedure is executed to refer to the member list in the DB 17 (804) and, if there is any service transaction of the member 4, (805), update the point service using information of the member including the total number of transactions, the total number of obtained points, the date of the initial transaction, and the data of the last transaction (806). If the member 4 has a family attribute, the procedure is executed to update the point service using information of the family including the total number of transactions of the subject family, the total number of obtained points thereof, the date of the initial transaction thereof, and the date of the last transaction thereof. At a time, the procedure is also executed to update the point service using information of the shop 3 that has dealings with the member 4 including the total number of transactions of that shop 3, the total number of obtained points thereof, the date of the initial transaction thereof, and the date of the last transaction thereof (807). Next, if the premium transaction of the member 4 takes place (808), the procedure is executed to update the point service using information of the member 4 including the total number of transactions of the member 4, the total number of consumed cases thereof, the date of the initial transaction thereof, and the date of the last transaction thereof (809). If the member 4 has a family attribute, likewise, the procedure is executed to update the point service using information of the family including the total number of transactions of the family, the total number of consumed cases thereof, the date of the initial transaction thereof, and the date of the last transaction thereof.

Also, the vendor point service using information is updated (810), which information includes the total number of transactions of the vendor 5 that has service dealings with the member 4, the total number of supplied points thereof, the date of the initial transaction, and the date of the last transaction. The foregoing process is repeated for all the members 4 on the member list and then the procedure is finished (811). The foregoing description is exemplary. The DB managing unit 18 serves to create two or more point service using statuses such as a monthly status, an annual status, and a total status.

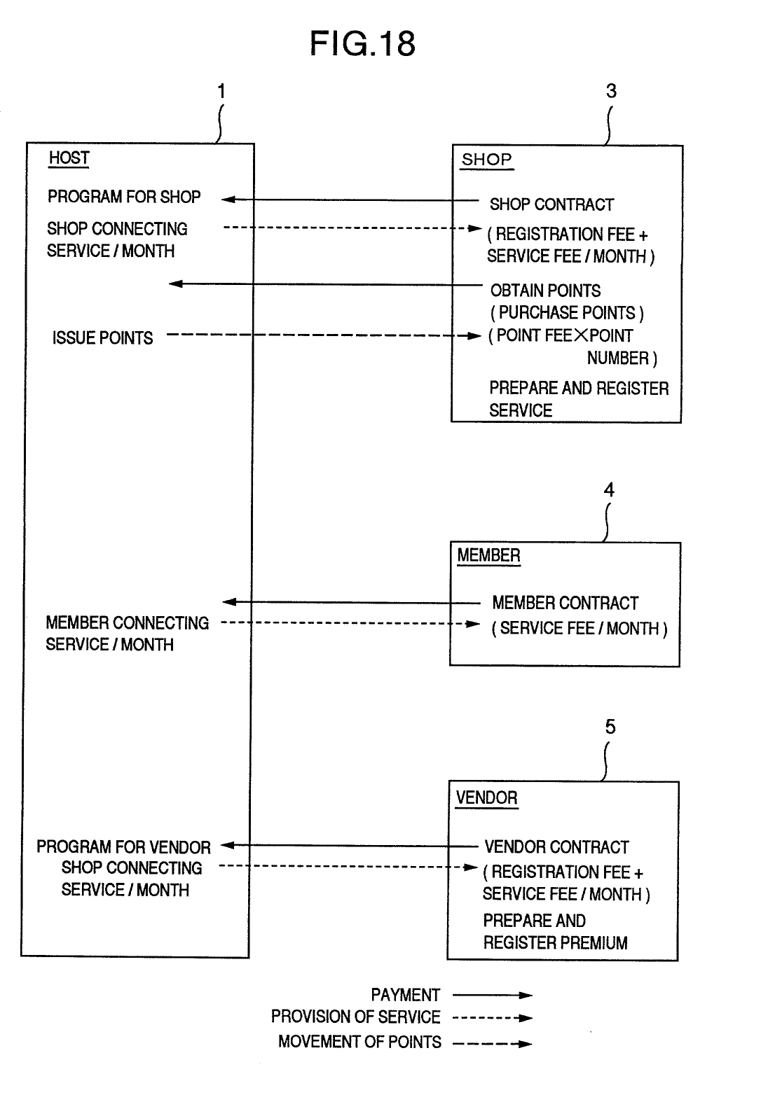

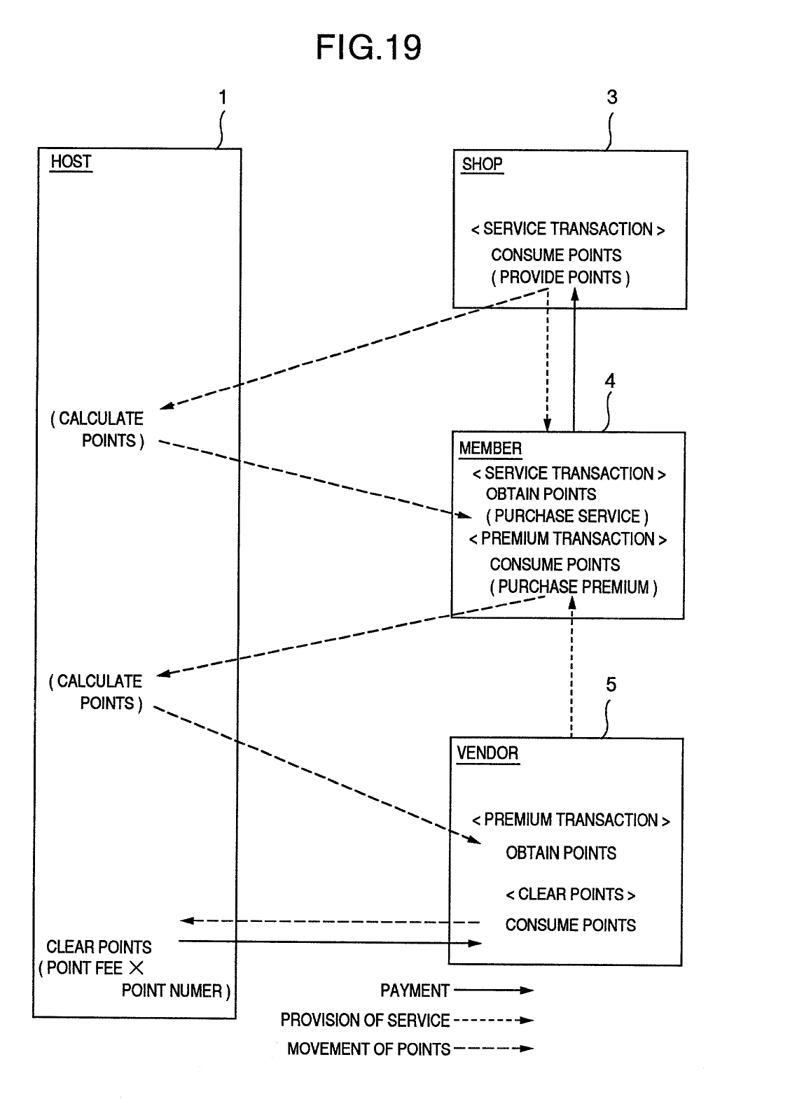

At last, one example of a business flow of the present point service system will be described below with reference to FIGS. 18 and 19.

FIG. 18 shows a business flow at the preliminary stage of a business in the point service system (ABC) according to the present invention. The system host 1 supplies a program for a client and obtains a registration fee as its price when the host 1 makes a new contract with the shop 3 or the vendor 5. Further, the connecting service fee is also obtained from the shop 3, the member 4 and the vendor 5. The connecting service for the member 4 may be free. The contract is flexibly promoted. Concretely, the contract is basically on the annual base, in which the connecting service fee is monthly. The registration fee and the connecting service fee are specified as the fixed cost of the system host 1. The shop 3 prepares and registers the service and purchases from the system host 1 the points corresponding to the cost and the quantity of the services to be purchased by the member 4 of the ABC. For the shop 3 and the vendor 5, the registration fee/connecting service fee correspond to the advertisement fee. The cost required by the shop to purchase the points corresponds to the discount of the service.

FIG. 19 shows a business flow at the stage of promoting a business in the point service system according to the present invention. When a service transaction is set up between the shop 3 and the member 4, the points possessed by the shop 3 are shifted to the member 4. When a premium transaction is set up between the member 4 and the vendor 5, the points possessed by the member 4 are shifted to the vendor 5. The vendor 5 pays the difference from/to the system host 1 on the points obtained by the premium transaction with the member 4 and thereby recovers the cost of the premium once a month.

The difference between the total amount of the point fee obtained from the shop 3 and the point fee to be paid to the vendor 5 is expected to be allocated to the variation cost of the system host 1 and the sales benefit. Hence, the point fee of the shop 3 is different from that of the vendor 5.

In the foregoing description, the embodiments of the present invention have been described in detail. The present invention is not limited to these embodiments. It may be embodied in other specific forms without departing from the spirit of the invention.

The point service system according to the invention employs a system of separating the virtual shops joining the system into the shop for supplying the customer with the service and the vendor for supplying the customer with the premium, which is served as means of giving-back the points. Hence, the point service system does not need any adjustment among the virtual shops joining the system. Further, the point service system employs a system of summing the transactions between the virtual shops and the members on the basis of the number of points supplied/points consumed on the member basis notified from the virtual shop, so that the transaction between the virtual shop and the member is made more independent of the point service to be given to the member. The use of the foregoing two systems makes it possible to reduce the adverse effect of an illegal act or bankruptcy of a specific virtual shop on another virtual shop or the point service system itself to a minimum, resulting in allowing a variety of shops run by respective managers to safely join the point service system.

In turn, the virtual shop/customer who wants to join/take part in the point service system are examined before registration, the prompt contract is made, and the contract update guide is suppressed by considering the trace information on the transactions between the virtual shop and the customer. These effects make it possible to exclude the undesirable virtual shop/customer from the point service system and stably introduce the desirable customers to the excellent virtual shops.

Further, the point service system prepares a rule containing an upper limit and a lower limit of the number of points corresponding to the price range of the service/premium. The virtual shop allows the number of points to be flexibly and swiftly changed within the price range. The virtual shop enables to utilize this function for sales to be strategically and dynamically expanded. Hence, the present point service system allows the virtual shops joining the system itself to be competitive.

In addition, the point service system prepares the family attribute for each customer, in which family attribute a group of customers uses one purse, so that the points obtained by all the members of the family can be used by any member of the family and the points obtained by all the members of the family can be used by a specific member of the family. This is highly convenient for each customer.

The point service system is arranged to provide the function corresponding to the virtual shop and allow the firm having no virtual shop as its business base to join the system itself. This arrangement makes a great contribution to the economic activity.

What is claimed is:

1. A point service system for providing the points corresponding to a service to be supplied to a customer who purchases said service in a virtual shop joined on a network, comprising:
information storing means for storing at least a number of accumulated points of each customer;
shop support means for being given reports on information for specifying a customer and first transaction information containing the supplied point number from a virtual shop (simply referred to as a shop) that supplies the service when a service transaction takes place and adding said supplied point number to the accumulated point number of said customer; and
vendor support means for being given reports on information for specifying a customer and second transaction information containing a number of consumed points from a virtual shop (referred to as a vendor) for providing a premium when a premium transaction takes place and subtracting said number of consumed points reported from said vendor from the accumulated point number of said customer.

2. A point service system as claimed in claim 1, wherein said information storing means pre-stores a first rule for specifying a range of the point number corresponding to a price of the service to be supplied and a second rule for specifying a range of the point number corresponding to a price of the premium to be supplied, said shop support means checks validity of said supplied point number sent from said shop according to said first rule, and said vendor support means checks validity of said consumed point number sent from said vendor according to said second rule.

3. A point service system as claimed in claim 1, wherein a time stamp and a serial number are added to said first and second transaction information sent from said shop and vendor and said transaction information is stored in said information storing means.

4. A point service system as claimed in claim 1 further comprising shop registering means for examining whether or not a shop is permitted to be registered and vendor registering means for examining whether or not a vendor is permitted to be registered.

5. A point service system as claimed in claim 1 wherein contract term information and a rule for noticing a term expiration of each shop are pre-stored in said information storing means and the term expiration is noticed to the shop in question according to said rule.

6. A point service system for providing the points corresponding to a service to be supplied to a customer (referred to as a member) who purchases the service in a virtual shop joined on a network and providing a premium to the member according to the number of said points, comprising:
information storing means for storing at least a number of accumulated points of each member;
shop support means for being given reports on information for specifying a member and first transaction information containing a number of provided points from a virtual shop (referred to as a shop) for providing a service when a service transaction takes place and adding the number of provided points reported from said shop to the number of accumulated points of said member; and
vendor support means for being given reports on information for specifying a member and second transaction information containing the number of consumed points from a virtual shop (referred to as a vendor) that is expected to provide a premium when a premium transaction takes place and subtracting the number of consumed points reported from said vendor from the number of accumulated points of said member; and
member support means for reporting to said member first point information containing the added result of said accumulated points given by said shop support means and second point information containing the subtracted result of said accumulated points given by said vendor support means.

7. A point service system as claimed in claim 6, wherein a time stamp and a serial number are added to said first and second transaction information sent from said shop and said vendor and the result is stored in said information storing means.

8. A point service system as claimed in claim 6, further comprising:
shop registering means for examining whether or not a shop is permitted to be registered;
vendor registering means for examining whether or not a vendor is permitted to be registered; and
member registering means for examining whether or not a member is permitted to be registered.

9. A point service system as claimed in claim 6, wherein contract term information of each shop and member and a rule for noticing a term expiration are pre-stored in said information storing means, and the term expiration is noticed to said shop and member according to said rule.

10. A point service system as claimed in claim 1, wherein information for defining a plurality of customers as one family is pre-stored in said information storing means so that the total points of the family may be replaced with the premium.

11. A point service system as claimed in claim 1, wherein information for defining a plurality of customers as one family and information for specifying a boss member of said family are pre-stored in said information storing means so that a right of replacing the total points of said family with the corresponding premium is given to said boss member.

12. A point service system as claimed in claim 1, wherein statistical information of the point service at a shop unit, a customer unit and a family unit is stored in said information storing means.

13. A point service system for providing the corresponding points to a service to be supplied to a customer (referred to as a member) who purchases the service in a virtual shop and providing the premium corresponding to said point number to the member, comprising:
information storing means for storing at least a number of accumulated points of each member;
first shop support means for being given reports on information for specifying a joining member and first transaction information containing the number of provided points through a network from the virtual shop (referred to as a first shop) that provides a service when a service transaction takes place and adding the number of provided points reported from said first shop to the number of accumulated points of said member;
first vendor support means for being given reports on information for specifying a joining member and second transaction information containing the number of consumed points through said network from a virtual shop (referred to a first vendor) for providing a premium when a premium transaction takes place and subtracting the number of consumed points reported from said first vendor from the number of accumulated points of said member;
second shop support means for being given reports on information for specifying a joining member and third transaction information containing the number of provided points from a virtual shop (referred to as a second shop) for providing a service when a service transaction takes place through an inter-program communicating means and adding the number of said provided points reported from said second shop to the number of accumulated points of said member; and
second vendor support means for being given reports on information for specifying a joining member and fourth transaction information containing the number of consumed points from a virtual shop (referred to as a second vendor) for providing a premium when a premium transaction takes place through an inter-program communicating means and subtracting the number of consumed points reported from said second vendor from the number of accumulated points of said member.

14. A method of processing a point service in a point service system for providing the corresponding points to a service to a customer who purchases the service in a virtual shop joined on a network, comprising the steps of:
reporting to a system host information for specifying a customer and information containing the number of provided points each time a virtual shop for providing a service (referred to as a shop) provides a service to a customer and enabling said system host to add the number of provided points reported therefrom to the number of accumulated points of each customer as the number of obtained points of the customer for updating the accumulated point number of the customer, and reporting the information containing the updated accumulated points to the customer; and
reporting to said system host information for specifying a customer and information containing the number of obtained points each time a virtual shop for providing a premium (referred to as a vendor) provides a premium to a customer, enabling said system host to subtract the number of obtained points reported from said vendor from the number of accumulated points of each customer as the number of consumed points of the customer for updating the number of accumulated points of each customer, and reporting information containing said updated accumulated points to each customer.

15. A method of processing a point service as claimed in claim 14, wherein said system host checks if the point number noticed from said shop or vendor meets a predetermined condition and sends the checked result to said shop or vendor.

16. A method of processing a point service as claimed in claim 15, wherein when said shop or vendor receives the checked result indicating no problem from said system host, said shop or vendor reports to a customer a service transaction is established.

17. A method of processing a point service as claimed in claim 16, wherein said customer reports claim information to said system host if said service processing is problematic.

18. A method of processing a point service as claimed in claim 16, wherein if a customer fulfills a payment for a service, said shop reports to said system host service stopping information to said customer.

19. A method of processing a point service as claimed in claim 18, wherein when said system host receives a notice of said service stopping information, said system host operates to perform a process of returning the accumulated point number of said customer and report the information containing the return-processed accumulated point number to said customer.

20. A method of processing a point service as claimed in claim 14, wherein said shop may set any number of points in the range of the point number corresponding to the price of the service pre-registered in said system host.

21. A method of processing a point service as claimed in claim 14, wherein said vendor may set any number of points in the range of the point number corresponding to a premium price pre-registered in said system host.

22. A method of registering a virtual shop in a point service system for providing the points corresponding to a service to a customer who purchases said service in a virtual shop joined on a network, comprising the steps of:
enabling said virtual shop to accept a registration key from a system host by sending predetermined examination information to said system host; and
enabling said virtual shop to download a program for a virtual shop from said system host by sending said registration key and contract information to said system host.

23. A method of registering a member in a point service system for providing the number of points corresponding to a service to a customer (referred to as a member) who purchases a service in a virtual shop joined on a network, comprising the steps of:
enabling said member to accept a registration key from a system host by sending predetermined examination information to said system host; and
enabling said member to send said registration key and contract information to said system host.

24. A method of managing a contract term of a virtual shop in a point service system for providing the number of points corresponding to a service to a customer who purchases said service in a virtual shop joined on a network, comprising the steps of:
periodically referring to contract term information and a rule for noticing a term expiration of each virtual shop pre-registered in a system host; and
reporting a notice of a term expiration to the virtual shop according to said term expiration notice rule unless the contract term is expired.

25. In a computer for realizing a virtual shop for providing points to a customer as a result of providing a service to a customer on a network, a recording medium for storing a program having the functions of:
providing a service after making sure that the customer is a member;
noticing to a system host information for specifying said member and the number of points corresponding to said provided service after said service is provided;
receiving checking information for indicating validity of a transaction from said system host; and
reporting to a member the fact that a service transaction is established when receiving the checking information for indicating no problem from said system host.

26. In a computer for realizing a virtual shop for obtaining points in association with provision of a premium to a customer on a network, a recording medium for storing a program having functions of:
providing a premium after making sure that the customer is a member;
noticing to a system host information for specifying said member and the number of obtained points corresponding to said provided premium after provided said premium;
receiving checking information for indicating validity of a transaction from said system host; and
reporting to a member the fact that the premium transaction is established when the checking information for indicating no problem is received from said system host.

27. A method of processing points of a customer in a point service system for providing the points corresponding to a service to a customer who purchases the service on a virtual joined on a network and providing the premium corresponding to said point number to the customer, comprising the methods of:
noticing to a system host by the virtual chop information for specifying a customer and the number of provided points by the virtual shop each time the virtual shop provides a service to the customer;
enabling said system host to add the noticed provided point number to the number of accumulated points of the customer as the number of obtained points of said customer;
noticing to said system host by the virtual shop information for specifying a customer and the number of obtained points each time the virtual shop provides a premium to the customer; and
enabling said system host to subtract the noticed number of obtained points from the number of accumulated points of the customer as the number of consumed points of said customer.

28. A method of processing points of a virtual shop in a point service system for providing the points corresponding to a service to a customer who purchases the service in a virtual shop joined on a network and providing the premium corresponding to the point number to said customer, comprising the steps of:
enabling the virtual shop for providing a service to purchase the points to be provided to a customer from a system host and provide the points corresponding to a service to each customer each time said service is provided to each customer, thereby consuming the points to be provided to each customer; and
enabling the virtual shop for providing a premium to obtain the points corresponding to a premium each time said premium is provided to each customer and adjust the points obtained within a certain term between the virtual shop itself and said system host, thereby consuming said points.
